(19) United States
(12) Patent Application Publication
(10) Pub. No.: US 2024/0246019 A1
(43) Pub. Date: Jul. 25, 2024

(54) SMOKE-CAPTURING DEVICE

(71) Applicant: John David Pandrea, JR., Cheney, WA (US)

(72) Inventor: John David Pandrea, JR., Cheney, WA (US)

(21) Appl. No.: 18/158,012

(22) Filed: Jan. 23, 2023

(51) Int. Cl. B01D 46/62; A24F 13/00; B01D 39/06; B01D 39/14; B01D 46/00

(52) U.S. Cl. CPC B01D 46/62; A24F 13/00; B01D 39/06; B01D 39/14; B01D 46/0001; B01D 46/0005; B01D 46/0036

(57) ABSTRACT

A smoke-capturing device is disclosed. The smoke-capturing device can include a cap comprising an inlet and a first cavity; a particulate filter arranged in the first cavity; a second filter assembly arranged in the first cavity, wherein the second filter assembly comprises a first housing connected to a second housing, a second cavity being formed by the first housing and the second housing, a second seal being formed between the cap and the second filter assembly by the arrangement of the second filter assembly in the cavity, a first seal being formed between the first housing and the second housing; a first screen arranged in the second cavity; a gas and/or vapor filter arranged in the second cavity; and a second screen arranged in the second cavity, the gas and/or vapor filter being arranged inward from the first screen, and the second screen.

### BACKGROUND

A protective covering can create a barrier between a person and an ambient environment. A protective covering can shield a person from being exposed to the harmful effects of their environment. A protective covering can also protect against a person exposing an environment to a harmful effect.

### BRIEF DESCRIPTION OF THE DRAWINGS

FIG. 1 is an illustration of a smoke-capturing device, according to one or more embodiments.

FIG. 2 is a block diagram of a cross-section of a smoke-capturing device, according to one or more embodiments.

FIG. 3A is a plan view of a first housing of a smoke-capturing device, according to one or more embodiments.

FIG. 3B is a side view of the first housing of the smoke-capturing device, according to one or more embodiments.

FIG. 4A is a plan view of a second housing of a smoke-capturing device, according to one or more embodiments.

FIG. 4B is a side view of the second housing of the smoke-capturing device, according to one or more embodiments.

FIG. 5A is a first side view of a cap of a smoke-capturing device, according to one or more embodiments.

FIG. 5B is a side view of the cap of the smoke-capturing device, according to one or more embodiments.

FIG. 5C is a side view of the cap of the smoke-capturing device, according to one or more embodiments.

FIG. 6 is a plan view of a cap of a smoke-capturing device, according to one or more embodiments.

FIG. 7A is a plan view of a first filter of a smoke-capturing device, according to one or more embodiments.

FIG. 7B is a side view of a first filter of the smoke-capturing device, according to one or more embodiments.

FIG. 8A is a plan view of a second filter of a smoke-capturing device, according to one or more embodiments.

FIG. 8B is a side view of the second filter of the smoke-capturing device, according to one or more embodiments

FIG. 9A is a plan view of a first screen of a smoke-capturing device, according to one or more embodiments.

FIG. 9B is a side view of a first screen of the smoke-capturing device, according to one or more embodiments.

FIG. 10 is an exploded side view of a second filter assembly of a smoke-capturing device, according to one or more embodiments.

FIG. 11 is a side view of a second filter assembly of a smoke-capturing device, according to one or more embodiments.

FIG. 12 is an exploded side view of a smoke-capturing device, according to one or more embodiments.

FIG. 13 is a side view of a smoke-capturing device, according to one or more embodiments

FIG. 14 is a process flow for assembling a smoke-capturing device, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details or with different specific details. Furthermore, well-known features may be omitted or simplified in order not to obscure the embodiments being described.

As used herein, the term cigarette can refer to a cigarette, a cigar, e-cigarette, or any other product used for burning a substance, inhaling smoke, and exhaling smoke. Smokers can inhale from lighted cigarettes and exhale mainstream smoke (“MS”). The composition of MS can include particulate matter pollutants and/or gas and/or vapor pollutants. Exhaled MS can introduce harmful effects on persons and on the environment surrounding a smoker through secondhand smoke.

Embodiments described herein address the above issues by providing a handheld smoke-capturing device designed to filter particulate pollutants and gas and/or vapor pollutants contained within the MS. The herein described smoke-capturing device is configured to be grasped in a user's hand to permit the smoker to exhale MS into the input of the smoke-capturing device and expel filtered air. The smoke-capturing device includes an input opening where a user can place their lips and form a seal with the smoke-capturing device. The user can exhale MS into the opening, and the smoke-capturing device can capture the smoke as it passes through two filters, one filter captures particulate pollutants, and the other filter captures gas and/or vapor pollutants. Filtered air can be released through an output opening of the smoke-capturing device as MS is exhaled into the input opening of the smoke-capturing device. Structurally, the smoke-capturing device can include a cap that includes an input orifice for receiving exhaled MS, a first filter, (e.g., particulate filter), and a second filter assembly, (e.g., gas and/or vapor assembly), that can include an output orifice for releasing filtered air. A cap can be attached to a second filter assembly, (gas and/or vapor filtration system). The first filter can be secured between the cap and a second filter assembly within the smoke-capturing device. In some embodiments, the first filter can be arranged proximate to the input opening to cause the MS to pass through the first filter prior to passing through the second filter assembly.

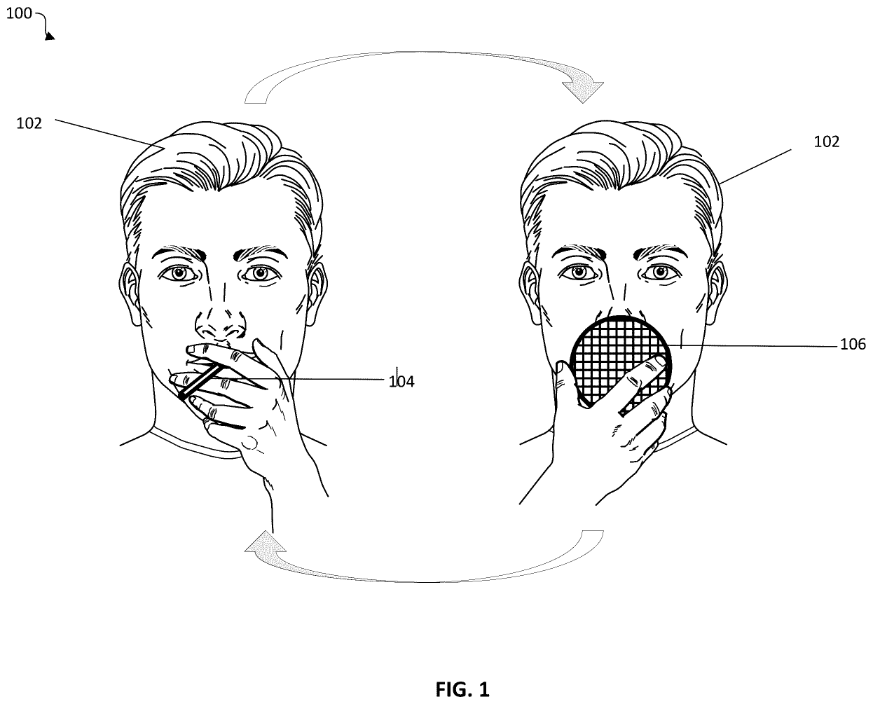

FIG. 1 is an illustration 100 of a smoke-capturing device, according to one or more embodiments. As illustrated, a user 102 can inhale smoke from a cigarette 104. Prior to exhaling the MS, the user 102 can move the cigarette away from their lips while keeping MS from behind exhaled. The user 102 can then move the smoke-capturing device 106 against their lips with their hand and exhale. The exhaled MS can pass through two filters before being released from the smoke-capturing device 106. In some embodiments, the smoke-capturing device 106 can include a cap, (cover), with a mount for pursing one's lips against. The mount can include an orifice for directing the MS into a filtration system of the smoke-capturing device 106. For example, the MS can pass through a first filter. The particulate filtered MS can exit the first filter and enter into a second filter assembly. The particulate filtered MS can pass through the second filter assembly. The particulate filtered and gas and/or vapor filtered MS can exit the second filter assembly of the smoke-capturing device 106 through an opening into the ambient atmosphere. After exhaling the MS into the smoke-capturing device 106 which passes through the smoke-capturing device 106 and exits as clean air, the user 102 can move the smoke-capturing device 106 away from their lips. The user 102 can then move the cigarette 104 back to their lips and inhale again.

The user 102 can repeat these steps of alternating between the cigarette 104 and the smoke-capturing device 106 until the user 102 is done smoking. As illustrated, the cigarette 104 can be held in one hand and the smoke-capturing device 106 can be held in the other hand. Therefore, the smoke-capturing device 106 offers a portable solution for keeping exhaled MS from being released into the ambient environment of the user 102.

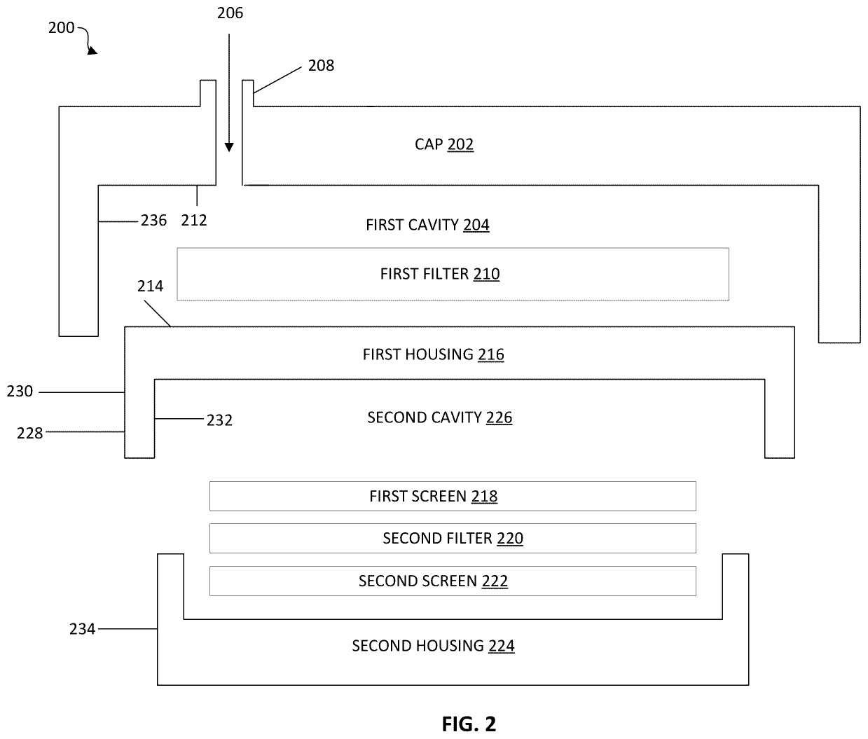

FIG. 2 is a block diagram of a cross-section of a smoke-capturing device 200, according to one or more embodiments. The smoke-capturing device 200 includes a cap 202. The cap 202 can be formed from various materials, such as a heat-resistant plastic, and be configured to have a size and shape to permit a user to comfortably grasp the smoke-capturing device 200 in their hand. The surface profile of the cap 202 can further be configured to permit the user to comfortably grasp the smoke-capturing device 200.

The cap 202 can generally include a bowl-like cross-section, such that the cap 202 can form a first cavity 204, (e.g., an open chamber). The cap 202 can be attached to the other components of the smoke-capturing device 200. The cap 202 can include an inlet 206, (input orifice), for receiving exhaled MS from a user. The inlet 206 can extend from an outer surface of the cap 202 to an inner surface of the cap 202. The surface profile of the outer surface surrounding the inlet 206 can include a mouthpiece 208, configured to permit the user to place their lips on the outer surface area surrounding the inlet 206 to form a seal. For example, the user can place their lips on the mouthpiece 208 and around the inlet 206 to form a seal with the cap 202 and exhale MS through the inlet 206 into the first cavity, (open chamber) 204 of the smoke-capturing device 200.

The smoke-capturing device 200 can further include a first filter 210. The first filter 210 can be arranged inward from the inner surface 212 of the cap 202 and can be held in place along the inner surface 212 of the cap 202 and a first surface 214 of the first housing 216 of the second filter assembly. The inner surface 212 of the cap 202 can be planar to the first surface 214. The first filter 210 can be a particulate filter configured to remove particulates from the MS exhaled into the inlet 206, after the MS passes through the first cavity 204. In some embodiments, the first filter 210 can be a high efficiency particulate air (HEPA) filter.

The smoke-capturing device 200 can further include a second filter assembly (e.g., gas and/or vapor filter assembly), that includes the first housing 216, a first screen 218, a second filter 220 (e.g., gas and/or vapor), a second screen 222, and a second housing 224. The first housing 216 and the second housing 224 can both be formed from various materials, such as a heat-resistant plastic, similar to the material that makes up the cap 202. The first housing 216 and second housing 224 can each generally include a bowl-like cross-section, such that when connected together can form a second cavity 226 that tightly contains the components of the second filter, (first screen 218, second filter 220 (e.g., a gas vapor filter that uses activated spherical charcoal particles), and second screen 222), of the second filter assembly. Structurally, the first housing 216 can include a mesh. In some embodiments, the mesh can be a grid structure with openings (e.g., ¼ in. by ¼ in. openings) and a lip 228 around the perimeter of the mesh. The lip 228 of the first housing 216 can extend away from the first surface 214 of the first housing 216 and can be generally orthogonal to an outer lateral surface 230 of the lip 228 of the first housing 216.

The smoke-capturing device 200 can further include a first screen 218. The first screen 218 can include a thin fibrous material that allows the particulate filtered MS to pass through. In some embodiments, the second filter 220 includes activated spherical charcoal particles. In these embodiments, the first screen 218 can further contain the activated spherical charcoal particles which make up the second filter 220.

The second filter 220 can be a gas and/or vapor filter that can use a filter media, such as spherical charcoal particles that have been treated with oxygen to open up pores between the carbon atoms. These “activated” spherical charcoal particles can adsorb gas and/or vapor from exhaled MS. The activated spherical charcoal particles surface areas provide bonding sites for the gas and/or vapor pollutants, that are contained within the MS. In the event that a particular substance (e.g., gas and/or vapor pollutants) passes near the activated spherical charcoal particles surfaces, the substance can attach to the surfaces of the activated spherical charcoal particles and become trapped. The second filter 220 can remove gas and/or vapor pollutants, while allowing filtered air to pass through.

The smoke-capturing device 200 can further include a second screen 222. The second screen 222 can include a thin fibrous material that allows filtered air to pass through. In embodiments, in which the second filter 220 includes activated spherical charcoal particles. The second screen 222 can contain the activated spherical charcoal particles from passing through the second screen 222. The first screen 218 can be arranged inward from the first housing 216 and the second filter 220. The second screen 222 can be arranged inward from the second filter 220 and the second housing 224.

The structure of the second housing 224 can generally be similar to the first housing 216. The second housing 224 can also include a mesh output opening, (e.g., a grid-like mesh with ¼ in. by ¼ in. openings). The mesh holes can be configured to allow filtered air to pass through. The lip of the second housing 224 can extend away from the second housing mesh.

The inner lateral surface 232 of the first housing 216 can be connected to the outer lateral surface 234 of the second housing 224. For example, the outer lateral surface 234 of the second housing 224 can be slid into the inner lateral surface 232 of the first housing 216. The inner lateral surface 232 of the first housing 216 can press against the outer lateral surface 234 of the second housing 224 holding the first housing 216 and the second housing 224 together. In other embodiments, the inner lateral surface 232 of the first housing 216 and the outer lateral surface 234 of the second housing 224 can include threaded portions to screw together. In some embodiments, the first housing 216 and the second housing 224 can be permanently connected to each other through an adhesive, (e.g., contact cement, thermal plastic resin, etc.).

The second filter assembly formed by the first housing 216 attached to the second housing 224 with the first screen 218, the second filter 220, and the second screen 222 contained within, can be connected to the cap 202. In some embodiments, the diameter of the outer lateral surface 230 of the first housing 216 can be close to the diameter of the inner lateral surface 236 of the cap 202 to allow the second filter assembly to be inserted into the first cavity 204. Each of the outer lateral surface 230 of the first housing 216 and the inner lateral surface 236 of the cap 202 can include a ribbed surface. The second filter assembly can remain in position in the cap 202 due to the pressure applied to one another combined with the action of the two ribbed surfaces snapping past one another to hold together using a snap-on compression. In other embodiments, the outer lateral surface 230 of the first housing 216 and the inner lateral surface 236 of the cap 202 can include a threaded surface, allowing both to be screwed in together using the threaded surface. The connection between the cap 202 and the second filter assembly can be disconnectable, allowing the user to remove and replace the first filter 210, as needed, when the operational life of the first filter 210 expires during the operational life of the smoke-capturing device 200.

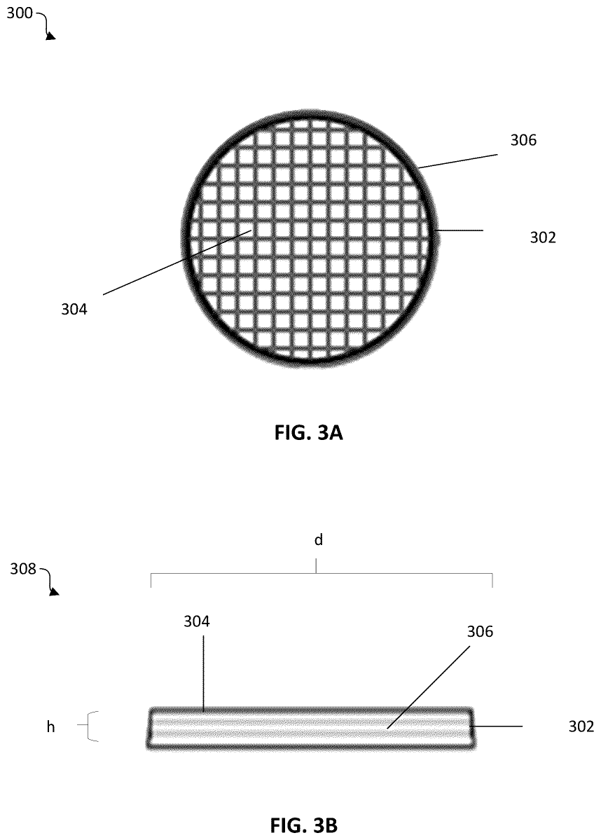

FIG. 3A is a plan view 300 of a first housing of a smoke-capturing device, according to one or more embodiments. As illustrated, the first housing 302 can include a mesh 304. In some embodiments, the mesh 304 can include ¼ in. by ¼ in. grid-like openings that can allow particulate filtered MS to pass through the grid holes, from a first filter to reach a second filter. The first housing 302 can further include a lip 306 that includes a ring attached to the perimeter of the mesh 304.

FIG. 3B is a side view 308 of the first housing 302 of the smoke-capturing device, according to one or more embodiments. As illustrated, the lip 306 of the first housing 302 forms a ring that extends out from and surrounds the mesh 304. The lip 306 can be generally orthogonal to the mesh 304 and extend away from the mesh 304. In some embodiments, the lip 306 can include a connecting feature, to allow the first housing 302 to be connected to a second housing (e.g., the second housing 224 of FIG. 2). In some embodiments, the first housing 302 has an approximate diameter, d, of three inches and a height, h, of approximately five-eighths of an inch.

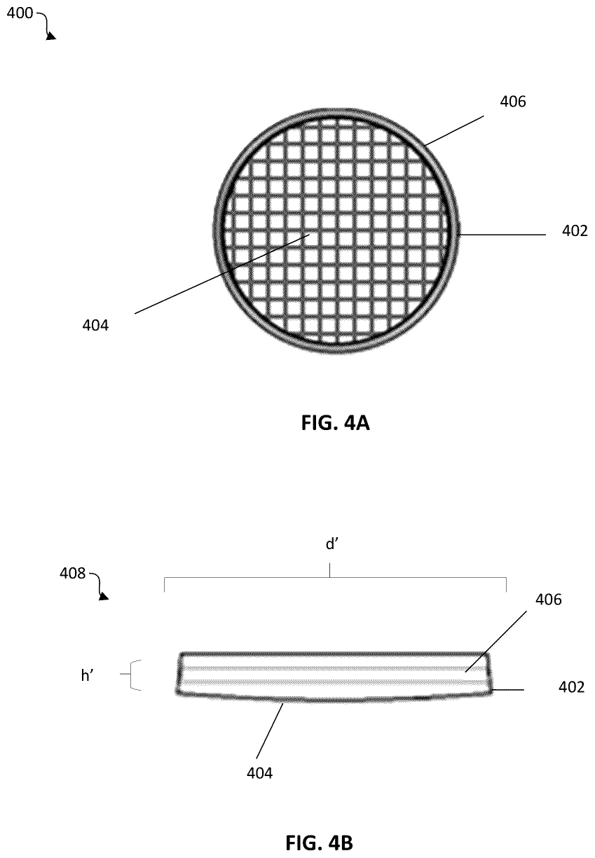

FIG. 4A is a plan view 400 of a second housing of a smoke-capturing device, according to one or more embodiments. As illustrated, the second housing 402 (e.g., the second housing 224 of FIG. 2) can include a mesh 404. In some embodiments, the mesh 404 can include ¼ in. by ¼ in. grid-like openings that can allow filtered MS to pass through the grid holes. The second housing 402 can further include a lip 406 that includes a ring attached to a perimeter of the mesh 404.

FIG. 4B is a side view 408 of the second housing 402 of the smoke-capturing device, according to one or more embodiments. As illustrated, the lip 406 of the second housing 402 forms a ring that extends out from and surrounds the mesh 404. The lip 406 can be generally orthogonal to the mesh 404 and extend away from the mesh 404. In some embodiments, the lip 406 can include a connecting feature, to allow a first housing (e.g., the first housing 216 of FIG. 2) to be connected to a second housing 402 (e.g., the second housing 224 of FIG. 2). In some embodiments, the second housing 402 has an approximate diameter, d′, of three inches and a height, h′, of approximately three-eighths of an inch. In practice, MS that is exhaled into the inlet of the smoke-capturing device can pass through the smoke-capturing device and be released as filtered air into the ambient atmosphere through the mesh 404 of the second housing 402.

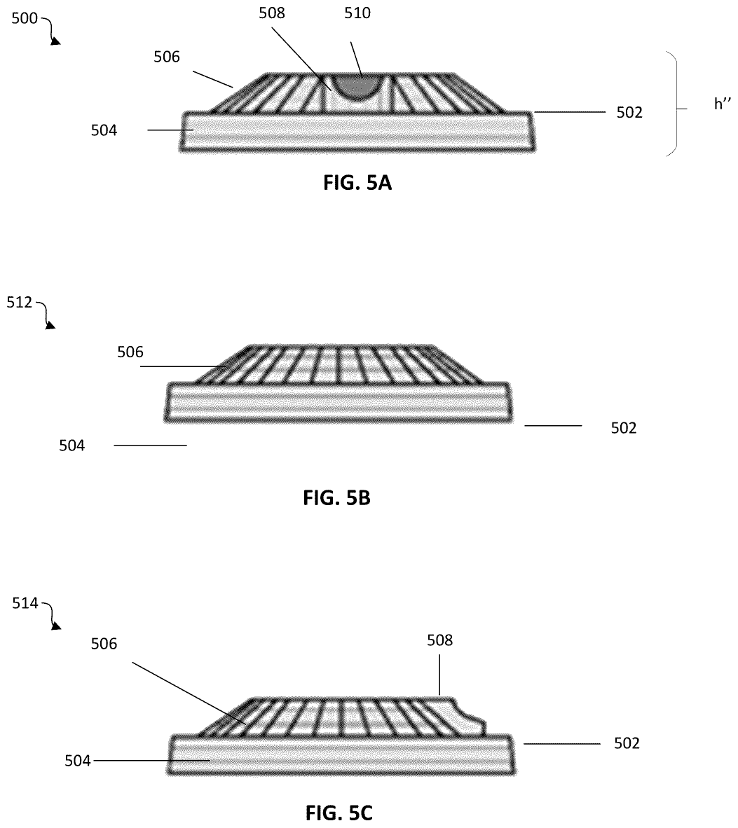

FIG. 5A is a first side view 500 of a cap of a smoke-capturing device, according to one or more embodiments. As illustrated, the cap 502 (e.g., the cap 202 of the FIG. 2) can include a cap lip 504 that forms a ring around the outside and extends away from the bottom of the raised portion 506 of the cap 502. The cap lip 504 can be generally orthogonal to and extend away from the raised portion 506. The cap 502 can form a first cavity (e.g., the first cavity 204 of FIG. 2). In some embodiments, the raised portion 506 can include a mouthpiece 508, and the mouthpiece 508 can include an inlet 510 (e.g., the inlet 206 of FIG. 2). In some embodiments, the cap 602 has a height, h″, of approximately seven-eighths of an inch. In practice, a user can exhale MS into the smoke-capturing device through the inlet 510. The MS can fill the first cavity and flow more evenly through the smoke-capturing device. FIG. 5B is a side view 512 of the cap 502 of the smoke-capturing device, according to one or more embodiments. It should be appreciated that the mouthpiece 508 is arranged on the opposite side, illustrated by FIG. 5A. FIG. 5C is a side view 514 of the cap 502 of the smoke-capturing device, according to one or more embodiments. As illustrated, the cap 502 includes the cap lip 504, the raised portion 506, and the mouthpiece 508.

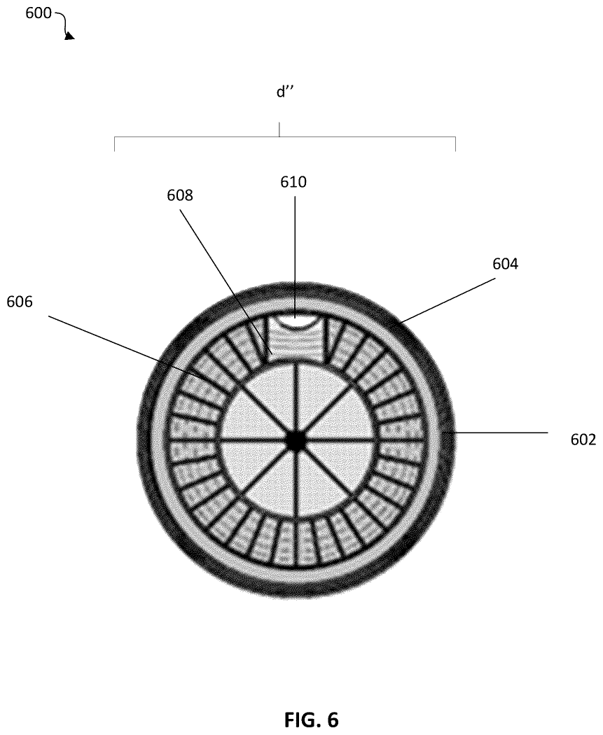

FIG. 6 is a plan view 600 of a cap of a smoke-capturing device, according to one or more embodiments. As illustrated, in some embodiments, the cap 602 (e.g., the cap 202 of FIG. 2 or the cap 502 of FIG. 5A, 5B, or 5C) can include a lip 604 arranged at the outer circumference of the raised portion 606 of the cap 602. In some embodiments, the raised portion 606 can include a mouthpiece (e.g., the mouthpiece 208 of FIG. 2 or the mouthpiece 508 of FIG. 5A), which can include an inlet 610 (e.g., the inlet 206 of FIG. 2 or the inlet 510 of FIG. 5A). The cap 602 can be made from any appropriate material, (e.g., a heat resistant polymer). In some embodiments, the cap 602 has a diameter, d″, of approximately three inches.

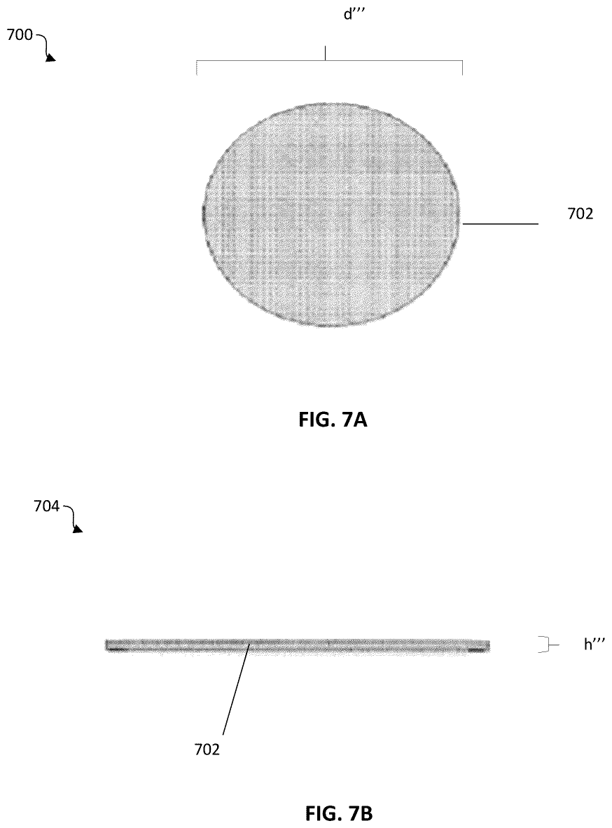

FIG. 7A is a plan view 700 of a first filter 702 of a smoke-capturing device, according to one or more embodiments. FIG. 7B is a side view 704 of a first filter 702 (e.g., the first filter 210 of FIG. 2) of the smoke-capturing device, according to one or more embodiments. The first filter 702 can be a particulate filter, (e.g., a high efficiency particle air (HEPA), filter, for filtering particulate contaminants from exhaled MS. According to one or more embodiments, the first filter 702 can have a diameter, d′″, of approximately two and seven eighths inches and a height, h′″, of approximately one eighth of an inch.

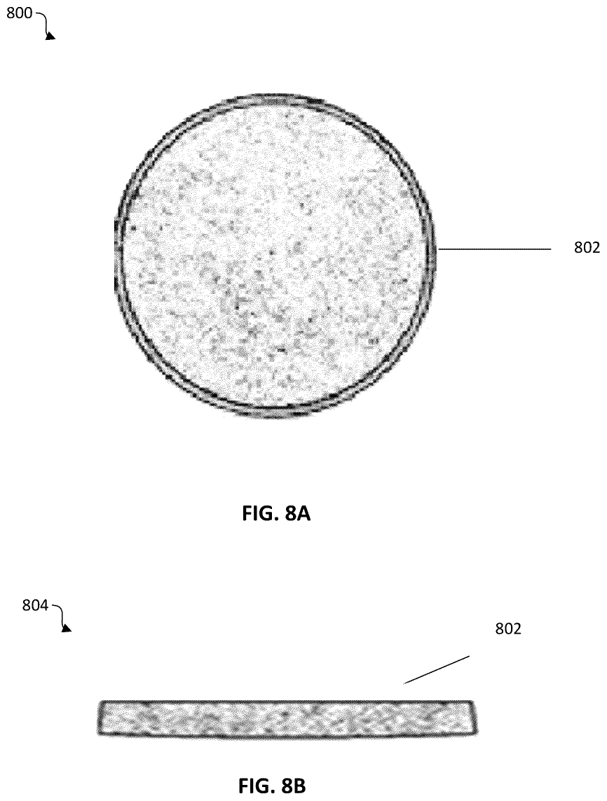

FIG. 8A is a plan view 800 of a second filter 802 of a smoke-capturing device, according to one or more embodiments. The second filter 802 (e.g., the second filter 220 of FIG. 2) can be a gas and/or vapor filter for filtering gas and/or vapor contaminants from exhaled MS. The second filter 802 can be comprised of activated spherical charcoal particles. The activated spherical charcoal particles can bind gas and/or vapor contaminants/pollutants, (e.g., gas and/or vapor contaminants contained within the exhaled MS), by adsorption of contaminant molecules, Van der Waals (inter-molecular) forces, effectively removing it. FIG. 8B is a side view 804 of the second filter 802 of the smoke-capturing device, according to one or more embodiments. The second filter 802, can be comprised of loose spherical charcoal particles, can be arranged, tightly, inward from a first screen and a second screen.

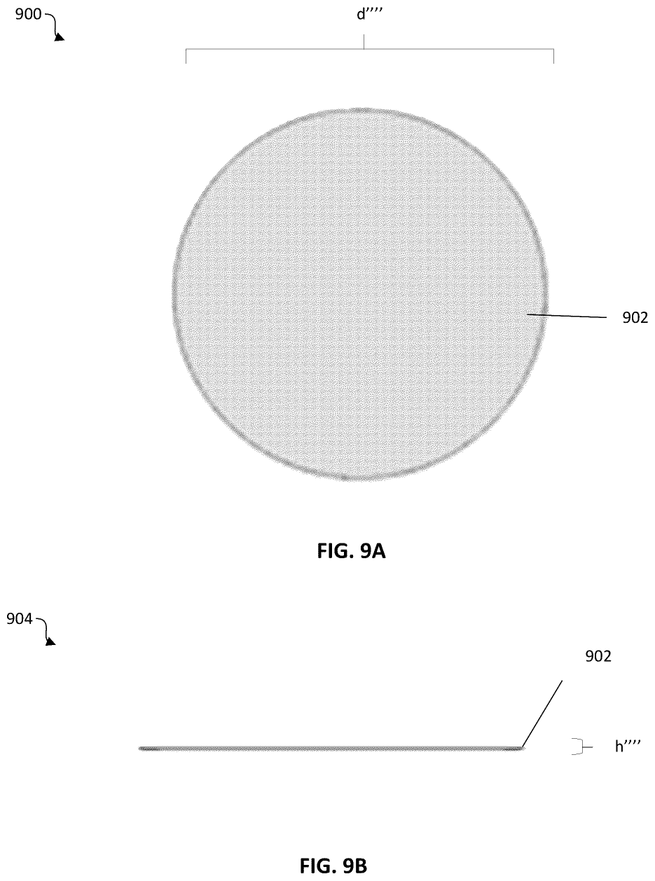

FIG. 9A is a plan view 900 of a first screen of a smoke-capturing device, according to one or more embodiments. The first screen 902 (e.g., the first screen 218 of FIG. 2), and second screen (e.g., the second screen 222 of FIG. 2), are identical according to one or more embodiments. FIG. 9B is a side view 904 of a first screen 902 of the smoke-capturing device, according to one or more embodiments. The first screen 902 can have a diameter, d″″, of approximately two and seven eighths of an inch, and a height, h″″, of approximately one sixteenth of an inch. As indicated above, the second filter assembly can include a second screen (e.g., the second screen 222 of FIG. 2) that can be identical to the first screen 902.

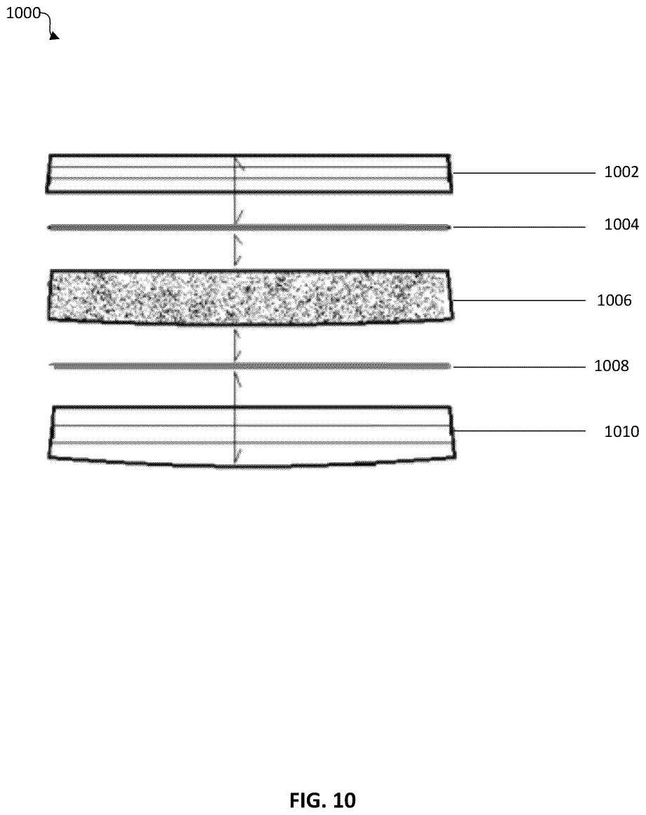

FIG. 10 is an exploded side view of a second filter assembly 1000 of a smoke-capturing device, according to one or more embodiments. The second filter assembly 1000 can include a first housing 1002 (e.g., the first housing 216 of FIG. 2 or the first housing 302 of FIG. 3), a first screen 1004 (e.g., the first screen 218 of FIG. 2 or the first screen 902 of FIG. 9), a second filter 1006 (e.g., the second filter 220 of FIG. 2 or the second filter 802 of FIG. 8), a second screen 1008 (e.g., the second screen 222 of FIG. 2 or the first screen 902 of FIG. 9), and a second housing 1010 (e.g., the second housing 224 of FIG. 2 or the second housing 402 of FIG. 4) to form the second filter assembly. The first housing 1002 and the second housing 1010 can each be bowl shaped, in which together can collectively form a second cavity (e.g., the second cavity 226 of FIG. 2) when the first housing 1002 is connected to the second housing 1010. For example, the second housing 1010 can slide into the first housing 1002.

The first screen 1004, the second filter 1006, and the second screen 1008 can be arranged in the second cavity that is created by securing the first housing 1002 to the second housing 1010. The first screen 1004 can be arranged proximate to the inside meshed surface of the first housing 1002 on one side of the first screen 1004 and proximate to the first surface of the second filter 1006 on the opposite side and the first screen 1004. The second screen 1008 can be arranged proximate to the second and opposite surface of the second filter 1006 on one side of the second screen 1008 and proximate to the inside meshed surface of the second housing 1010 on the opposite side of the second screen 1008. In this sense, the second filter 1006 can be secured tightly between the first screen 1004, and the second screen 1008, which are all secured tightly inside of the first housing 1002 and the second housing 1010 of the second filter assembly 1000 of the smoke-capturing device.

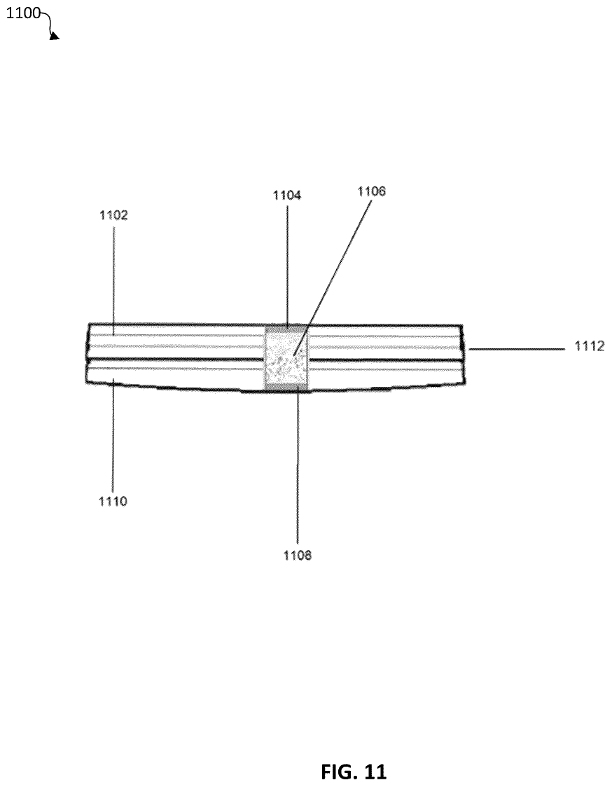

FIG. 11 is a side view 1100 of a second filter assembly of a smoke-capturing device, according to one or more embodiments. For illustration purposes, a portion of the second filter assembly is exposed to reveal components arranged to form the second filter assembly 1112. The second filter assembly 1112 can include a first housing 1102 (e.g., the first housing 216 of FIG. 2, the first housing 302 of FIG. 3, or the first housing 1002 of FIG. 10), a first screen 1104 (e.g., the first screen 218 of FIG. 2, the first screen 902 of FIG. 9, or the first screen 1004 of FIG. 10), a second filter 1106 (e.g., the second filter 220 of FIG. 2 or the second filter 802 of FIG. 8, or the second filter 1006 of FIG. 10), a second screen 1108 (e.g., the second screen 222 of FIG. 2, the second screen 902 of FIG. 9, or the second screen 1008 of FIG. 10), and a second housing 1110 (e.g., the second housing 224 of FIG. 2, the second housing 402 of FIG. 4, or the second housing 1010 of FIG. 10). The first screen 1104, second filter 1106, and the second screen 1108 can be arranged and secured in the second cavity formed by connecting the first housing 1102 to the second housing 1110, forming the second filter assembly 1112.

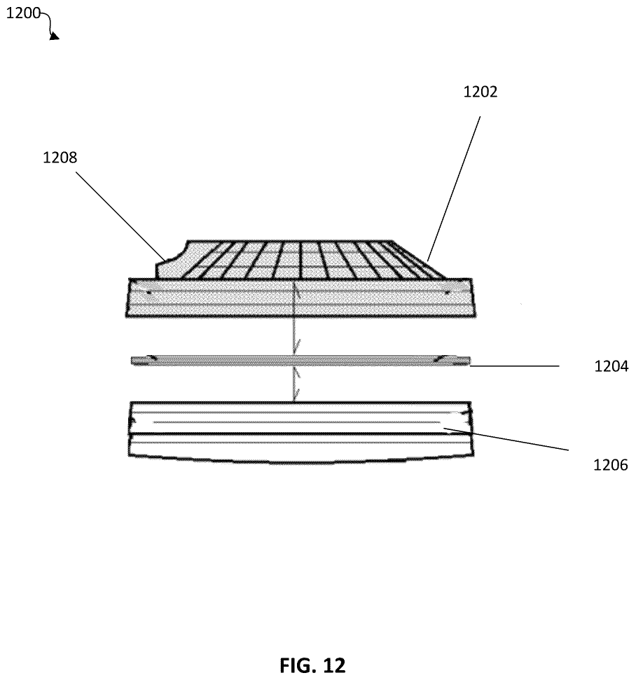

FIG. 12 is an exploded side view of a smoke-capturing device 1200, according to one or more embodiments. The smoke-capturing device 1200 can include a cap 1202 (e.g., the cap 202 of FIG. 2, the cap 502 of FIG. 5A, 5B, or 5C, or the cap 602 of FIG. 6), a first filter 1204 (e.g., the first filter 210 of FIG. 2 or the first filter 702 of FIG. 7A or 7B), and a second filter assembly 1206 (e.g., a second filter assembly as described above). The first filter 1204 can be arranged within a first cavity (e.g., the first cavity 204 of FIG. 2) of the cap 1202. The cap 1202 can be connected to the second filter assembly 1206 with the first filter 1204 held tightly in place, such that a seal is formed between the second filter assembly 1206 and the cap 1202 by which MS exhaled into an inlet of the cap 1202 cannot escape at any opening between the cap 1202 and the second filter assembly 1206. Rather, the MS can pass from an inlet 1208 (e.g., the inlet 206 of FIG. 2 or the inlet 510 of FIG. 5A) of the cap 1202 into the first cavity of the cap 1202 and through the first filter 1204, and on through the second filter assembly 1206, and then out of the second filter assembly 1206 into the ambient atmosphere as filtered air.

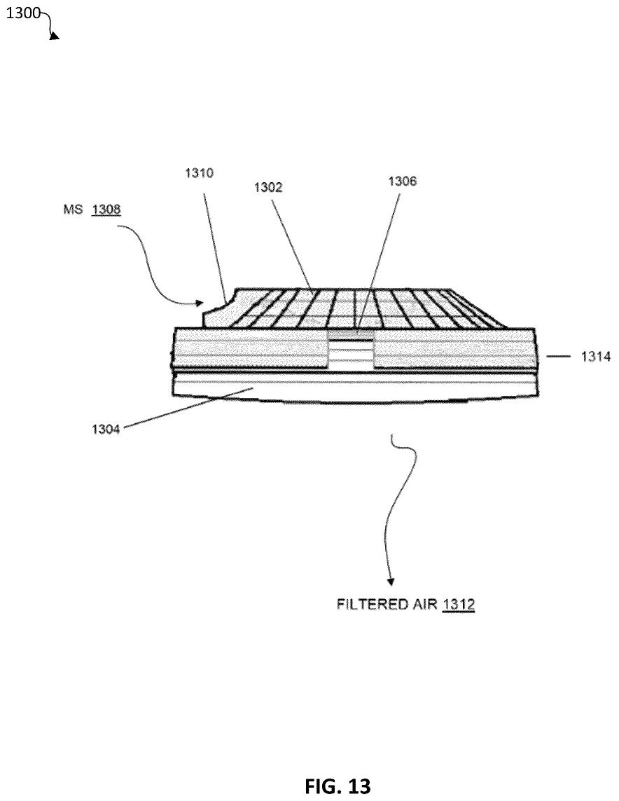

FIG. 13 is a side view 1300 of a smoke-capturing device, according to one or more embodiments. As illustrated, a portion of the cap 1302 (e.g., the cap 202 of FIG. 2, the cap 502 of FIG. 5A, 5B, or 5C, the cap 602 of FIG. 6, the cap 1202 of FIG. 12) has been removed to reveal the cap 1302 connected to the second filter assembly 1304 (e.g., the second filter assembly 1112 of FIG. 11 or the second filter assembly 1206 of FIG. 12) with the first filter 1306 (e.g., the first filter 210 of FIG. 2, the first filter 702 of FIG. 7A or 7B, or the first filter 1204 of FIG. 12) can be housed between the cap 1302 and the second filter assembly 1304. As illustrated, the smoke-capturing device 1314 includes a cap 1302 connected to a second filter assembly 1304, with a first filter 1306 housed tightly between the two. A user can exhale MS 1308 into an inlet 1310 (e.g., the inlet 206 of FIG. 2, the inlet 510 of FIG. 5A, or the inlet 1208 of FIG. 12) of the cap 1302. The MS can enter the first cavity of the cap 1302 and pass through a first filter 1306. The particulate filtered MS can exit the first filter 1306 and enter into the second filter assembly 1304. The particulate and gas and/or vapor contaminant filtered MS can exit the second filter assembly 1304 and enter the ambient atmosphere as filtered air 1312. For example, if a user is a smoker who exhales MS 1308 into the smoke-capturing device 1314, the filtered MS can exit the smoke-capturing device 1314 as filtered air 1312 that is distinct from the MS 1308 that is exhaled into the smoke-capturing device 1314.

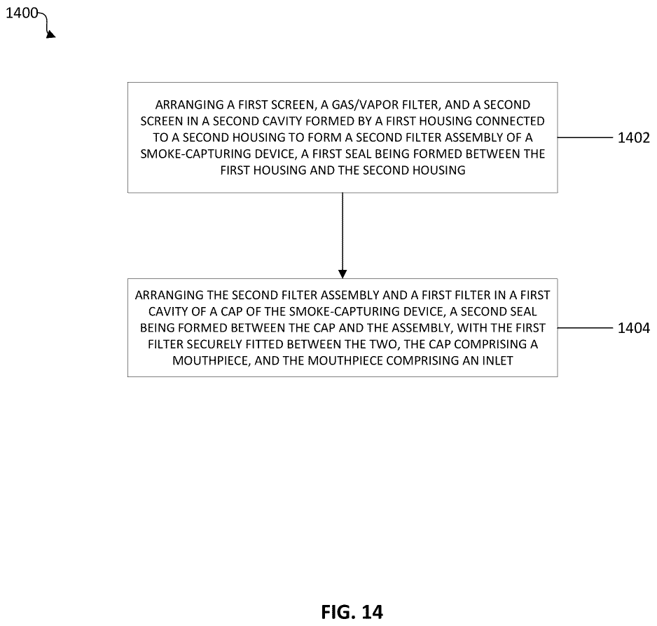

FIG. 14 is a process flow 1400 for assembling a smoke-capturing device, according to one or more embodiments. At 1402, the method can include arranging a first housing (e.g., the first housing 216 of FIG. 2, the first housing 302 of FIG. 3, the first housing 1002 of FIG. 10, or the first housing 1102 of FIG. 11), first screen (e.g., the first screen 218 of FIG. 2, the first screen 902 of FIG. 9, the first screen 1004 of FIG. 10, or the first screen 1104 of FIG. 11), second filter (e.g., the second filter 220 of FIG. 2, the second filter 802 of FIG. 8, the second filter 1006 of FIG. 10, or the second filter 1106 of FIG. 11), a second screen (e.g., the second screen 222, of FIG. 2, the second screen 902 of FIG. 9, the second screen 1008 of FIG. 10, or the second screen 1108 of FIG. 11), and a second housing (e.g., the second housing 224 of FIG. 2, the second housing 402 of FIG. 4, the second housing 1010 of FIG. 10, or the second housing 1110 of FIG. 11) to form a second filter assembly (e.g., the second filter assembly 1112 of FIG. 11, the second filter assembly 1206 of FIG. 12, or the second filter assembly 1304 of FIG. 13). A first seal is formed between the first housing and the second housing of the second filter assembly.

At 1404, the method can include arranging a cap (e.g., the cap 202 of FIG. 2, the cap 502 of FIGS. 5A, B and C, the cap 602 of FIG. 6, the cap 1202 of FIG. 12, or the cap 1302 of FIG. 13), that includes a mouthpiece (e.g. the mouthpiece 208 of FIG. 2, the mouthpiece 508 of FIG. 5A, or the mouthpiece 608 of FIG. 6), with an input opening, (e.g., the inlet 206 of FIG. 2, the inlet 510 of FIG. 5, the inlet 1208 of FIG. 12, or the inlet 1310 of FIG. 13), and a first cavity, (e.g., the first cavity 204 of FIG. 2), a first filter, (e.g., the first filter 210 of FIG. 2, the first filter 702 of FIGS. 7A and 7B, the first filter 1204 of FIG. 12, or the first filter 1306 of FIG. 13), and a second filter assembly, (e.g., the second filter assembly 1206 of FIG. 12, or the second filter assembly 1304 of FIG. 13), to form a smoke-capturing device. A dis-connectable second seal is formed between the cap and the second filter assembly, which allows the first filter to be replaced as needed. The inhaled MS can be exhaled into the opening of the cap into the first cavity of the cap, pass through the first filter and on through the second filter assembly. As the smoke is filtered through the smoke-capturing device, filtered air can be released into the ambient atmosphere.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined or replaced with any other examples.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments, (especially in the context of the following claims), are to be construed to cover both the singular and the plural, unless otherwise indicated herein or clearly contradicted by context. The terms “comprising,” “having,” “including,” and “containing” are to be construed as open-ended terms, (i.e., meaning “including, but not limited to,”), unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language, (e.g., “such as”), provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A smoke-capturing device, comprising:
a cap comprising an inlet and a first cavity;
a first filter, arranged in the first cavity;
a second filter assembly arranged in the first cavity, wherein the second filter assembly comprises a first housing connected to a second housing, a second cavity being formed by the first housing and the second housing, a first seal being formed between the first housing and the second housing and a second seal being formed between the cap and the second filter assembly by the arrangement of the second filter assembly in the first cavity;
a first screen arranged in the second cavity;
a second filter arranged in the second cavity; and
a second screen arranged in the second cavity, the second filter being arranged inward from the first screen and the second screen.

2. The smoke-capturing device of claim 1, wherein the device further comprises a mouthpiece arranged on the cap, and wherein the mouthpiece comprises the inlet.

3. The smoke-capturing device of claim 1, wherein the first filter comprises a high efficiency particulate (HEPA) filter.

4. The smoke-capturing device of claim 1, wherein the second filter comprises charcoal particles, and wherein the first screen comprises a mesh to contain the charcoal particles.

5. The smoke-capturing device of claim 1, wherein the second filter comprises charcoal particles arranged in the second cavity inward from the first screen and the second screen.

6. The smoke-capturing device of claim 1, wherein the second filter comprises charcoal particles, and wherein the second screen comprises a mesh arranged in the second cavity to contain the charcoal particles.

7. The smoke-capturing device of claim 1, wherein the second housing comprises an orifice that allows a gas to pass through to an ambient atmosphere.

8. The smoke-capturing device of claim 1, wherein the cap is connected to the second filter assembly.

9. The smoke-capturing device of claim 1, wherein the first housing is connected to the second housing.

10. The smoke-capturing device of claim 1, wherein the first housing and the second housing comprises a respective grid surface

11. The smoke-capturing device of claim 1, wherein a diameter of the smoke-capturing device is configured to permit the smoke-capturing device to be a handheld device.

12. The smoke-capturing device of claim 1, wherein the cap, the first filter and the second filter assembly each comprise a respective circular circumference.

13. The smoke-capturing device of claim 1, wherein the cap comprises a mouthpiece that extends away from the cap.

14. A method for assembling a smoke-capturing device, the smoke-capturing device comprising a first filter and a second filter assembly, the method comprising:
arranging a first screen, a second filter, and a second screen in a first cavity formed by a first housing connected to a second housing to form the second filter assembly of a smoke-capturing device, a first seal being formed between the first housing and the second housing; and
arranging the second filter assembly in a second cavity of a cap of the smoke-capturing device, a second seal being formed between the cap and the second filter assembly, the cap comprising a mouthpiece, and the mouthpiece comprising an inlet.

15. The method of claim 14, wherein the method further comprises arranging a first filter inward from the cap and the second filter assembly, wherein the first filter is a particulate filter and the second filter assembly is a gas and/or vapor filter.

16. A second filter assembly of a smoke-capturing device, the smoke capturing device comprising a first filter and the second filter assembly, the second filter assembly comprising:
a first housing configured to be arranged in a cavity of a cap of a smoke-capturing device;
a second housing connected to the first housing, the second housing configured to be arranged in the cap, a second cavity being formed by the first housing and the second housing;
a first screen arranged in the second cavity;
a gas filter arranged in the second cavity; and
a second screen arranged in the second cavity, the gas filter being arranged inward from the first screen and the second screen.

17. The assembly of claim 16, wherein a surface of the first housing comprises a ribbed surface configured for being coupled to the cap.

18. The assembly of claim 16, wherein the gas and/or vapor filter comprises a charcoal filter.

19. The assembly of claim 16, wherein the first housing and second housing comprise a mesh.

20. The assembly of claim 16, wherein the cap comprises a mouthpiece that extends away from the cap.
